(19) United States
(12) Patent Application Publication
(10) Pub. No.: US 2011/0171099 A1
(43) Pub. Date: Jul. 14, 2011

(54) PROCESS FOR MANUFACTURING A POROUS SIC MATERIAL

(75) Inventors: Christophe Augier, Avignon (FR); Ana-Maria Popa, Cavaillon (FR); Jostein Mosby, Mosby (NO)

(73) Assignee: SAINT-GOBAIN CENTRE DE RECH.ET D'ETUDES EUROPEEN, Courbevoie (FR)

(21) Appl. No.: 13/063,766

(22) PCT Filed: Sep. 29, 2009
(86) PCT No.: PCT/FR2009/051845

§ 371 Date: Mar. 14, 2011

(30) Foreign Application Priority Data
Sep. 30, 2008 (FR) 0856563

(51) Int. Cl. C01B 31/36; B29C 67/24; B29C 67/20; B29C 47/00

(52) U.S. Cl. 423/345; 264/414; 264/682; 264/638; 264/670

(57) ABSTRACT

The invention relates to a process for obtaining a porous material made of recrystallized SiC, especially in the form of a structure for filtering a particulate-laden gas, starting from at least two powders of fine and coarse SiC particles, blended with an organic material comprising an organic pore former and/or a binder, in suitable proportions and in the presence of a sufficient amount of a solvent, such as water, so as to allow forming of said blend and firing thereof between 1600° C. and 2400° C., said process being characterized in that the difference between the percentile d₉₀ of the coarse particle powder and the percentile d₁₀ of the fine particle powder multiplied by the volume of organic material in the initial blend, expressed as a percentage relative to the total volume of the SiC particles, is between 250 and 1500.

The invention also relates to the porous material made of recrystallized SiC that can be obtained by said process.

The present invention relates to the field of porous materials based on recrystallized silicon carbide. More particularly, the invention relates to a process for manufacturing a body or an element made of such a porous material, the mechanical strength properties of which are improved. Such a body or element may especially be used in the field of filtration or else in the field of firing supports or ceramic igniters.

Porous ceramic or refractory materials based on silicon carbide (SiC) obtained by sintering at very high temperature are being increasingly used in applications in which their high chemical inertness and their high refractoriness enable them to withstand high mechanical stresses, particularly thermomechanical stresses. Important, but nonlimiting, examples are typically applications such as particulate filters in motor vehicle exhaust lines. In particular, it is generally desirable for catalytic gas filtration treatment applications to increase the porosity, so as to obtain the highest possible exchange surface area, or to increase the mean size of the pores, so as to limit the pressure drop effects. In particular, it may be possible to deposit the catalytic coating within the porous material because of the fact that the material still has, after said deposition, sufficient porosity to allow gases to flow through it without excessive pressure drop.

However, when the material is highly porous, i.e. when its open porosity is greater than 40% or 45% or even 50%, and in an even more pronounced manner above 50%, the element produced from such materials has too low a mechanical, and consequently thermomechanical, strength, this weakness possibly being the cause of the material rapidly deteriorating in service.

In the same way, for a material intended for example to be used as a firing support, it is useful to increase the porosity while still maintaining mechanical strength, so as to reduce the thermal mass of the support and in particular to reduce the energy consumption needed for firing parts resting on said supports.

For the purpose of increasing the porosity of a material, the most conventional known means consists in using additives in the starting composition for obtaining the desired part or body. In particular, pore formers of organic origin are used, these decomposing during an intermediate heating step or during the firing of the material. Such a process has been described for example in patent application EP 1 403 231. However, as is known, using pore formers or other organic materials leads to toxic gases being given off and may furthermore cause defects in the material, such as microcracking, if the pore formers or other organic materials are not removed in a perfectly controlled manner. Such defects may then be highly damaging for the properties and the strength of the porous bodies when they are being used, most particularly particulate filters in an exhaust line which are subjected to successive filtration and regeneration phases, or for a firing support that has to undergo several substantial heat cycles.

Moreover, it is also known, for controlling and usually increasing the mean pore diameter of the final product, to increase the size of the SiC particles present in the starting blend. The use of large particles, i.e. typically those having a median diameter greater than 20 microns, leads however to an unacceptable reduction in mechanical strength.

Many recent publications address the problem of obtaining silicon carbide structures of controlled porosity from various powders of SiC particles in the initial blend.

EP 1 686 107 discloses for example a process for manufacturing a sintered ceramic body from a blend of at least two powders, one powder consisting of coarse SiC grains and one powder of fine SiC grains, in which the ratio of the mean size of the coarse powder to the mean size of the fine powder is between 8 and 250.

EP 1 652 831 describes sintered ceramic bodies obtained from a blend of two SiC particle powders having a mean diameter between 5 and 100 μm and between 0.1 and 10 μm respectively.

EP 1 839 720 discloses a method of preparing SiC filters having a small dispersion around a mean target value of the pore diameter. The two SiC powders initially used according to this teaching have a median diameter of 15 to 40 microns in respect of the powder consisting of the coarser particles and 0.5 microns in respect of the powder consisting of the finer particles.

The object of the present invention is to provide a process for preparing and synthesizing a body made of a recrystallized silicon carbide ceramic material, which is porous and has the best compromise between its porosity characteristics (open pore volume, median pore diameter) and its mechanical and thermomechanical strength characteristics.

More particularly, the subject of the present invention is a process for manufacturing an SiC-based porous ceramic or refractory product sintered at a temperature above 1600° C., making it possible to obtain a material having an improved compromise, compared with the methods known hitherto, between its porosity properties, in particular its open porosity and/or its median pore diameter, and its mechanical and thermo-mechanical strength properties.

The invention is based on the discovery made by the applicant that, for substantially equivalent porosity of the porous SiC material, certain parameters of the process for obtaining said material could have a very substantial influence on the mechanical strength characteristics of said material. Most particularly, the experiments carried out by the applicant, some of which are reported in the rest of the present description, have proved that the mechanical properties of the material, for equivalent porosity, could be very substantially improved by strict and combined control:
on the one hand, of the size and the distribution of the SiC grains present in the powder blend initially used in the process; and
on the other hand, of the amount of organic material present in the initial blend before firing.

According to one particularly advantageous aspect, by applying the present invention, it becomes possible, in comparison with expected porosity characteristics of the target material, to modify the critical steps of the process so as to obtain the highest mechanical characteristics for such a material.

More precisely, the invention relates to a process for obtaining a porous material made of recrystallized SIC, especially in the form of a structure for filtering a particulate-laden gas, comprising the following steps:
a) preparation of a composition comprising at least two powders of SiC particles, the particles of a first powder having a median diameter d₅₀ of less than 5 microns and the particles of a second powder having a median diameter d₅₀ of between 5 and 100 microns, the difference between the median diameter d₅₀ of the second powder and the median diameter d₅₀ of the first powder being greater than 5 microns;
b) blending of said composition with an organic material comprising an organic pore former and/or a binder, in suitable proportions and in the presence of a sufficient amount of a solvent, such as water, to allow said blend to be formed, and forming of the blend obtained in order to obtain a green body;
c) preferably, drying and removal of the organic material, especially by an intermediate heat treatment and/or by the use of microwaves; and
d) firing of the body at a sintering temperature between 1600° C. and 2400° C., preferably above 1800° C. or even above 2000° C., in order to obtain a sintered porous body.

In the process according to the invention the difference between the percentile d₉₀ of the second particle powder and the percentile d₁₀ of the first particle powder multiplied by the volume of organic material in the initial blend, expressed as a percentage relative to the total volume of the SiC particles, is between about 250 and about 1500, preferably between about 300 and about 1200.

The term “volume of organic material” is understood, within the context of the present description, to mean the total volume of all the organic materials blended with the SiC grains constituting the “mineral” part of the blend. This total volume of organic material is relative to the total volume occupied by said SiC grains in the blend.

The organic materials incorporated into the blend are especially agents having a pore-forming functionality and pre-forming agents, such as binders, plasticizers, dispersants and lubricants, without this list however being exhaustive.

Preferably, the volume of organic material (possible pore former, binding, plasticizing, lubricating agents, etc.) is between 5 and 150%, or even 20 to 110%, or even 30 to 100%, as a percentage relative to the total volume of SiC grains. Preferably, the pore former volume is between 0 and 120%, or 10 to 95% or even 15 to 80%, as a percentage relative to the total volume of SiC grains.

The term “powder” is conventionally understood, within the context of the present invention, to mean an assembly of grains or particles characterized by a particle diameter distribution (also called particle size in the present description) generally centered and distributed around a median diameter.

The term “grain” or the term “particle” is understood to mean an individual solid product in a powder or powder blend.

The expression “curve of the cumulative particle size distribution of the particle sizes of a powder or a powder blend” is understood, within the context of the present invention and in accordance with the common practice in the field, to mean the particle size distribution curve giving:
plotted on the y-axis, percentages such that a percentage p % represents the fraction of the powder, by volume, grouping together the p % of the particles having the largest diameters or sizes; and
plotted on the x-axis, the particle sizes or diameters dₚ, generally expressed in μm, dₚ being the smallest possible particle size in the volume fraction of the powder represented by the percentage p % plotted on the x-axis.

Such a particle size curve may especially be conventionally obtained using a laser particle size analyzer.

It will be recalled that dₚ, within the meaning of the present invention, is conventionally the particle diameter (plotted on the x-axis in the above-mentioned curve) corresponding to the percentage p % by volume.

Thus, the d₁₀ of a powder corresponds to a particle size for which 10% by volume of the particles of the powder have a size equal to or greater than d₁₀ (and consequently for which 90% of the particles, by volume, have a size strictly less than d₁₀). It will be recalled that d₉₀ of a powder corresponds to the particle size for which 90% by volume of the particles of the powder have a size equal to or greater than d₉₀ (and consequently for which 10% of the particles by volume have a size strictly smaller than d₉₀).

With the same definition, the percentile d₅₀ is often called the median diameter of a powder.

The process according to the invention consists for example in blending the SiC particle powders so as to obtain the particle blend of selected size according to the invention and then in forming this blend, and advantageously makes it possible to obtain, after firing and sintering at high temperature, an SiC-based porous refractory ceramic product, the combined porosity and mechanical strength characteristics of which are improved and may be more easily controlled. Thus, the process according to the invention makes it possible to obtain a porous sintered body, the optimum mechanical strength of which is guaranteed.

Preferably, according to the invention, the difference between the percentile d₉₀ of the second SiC particle powder and the percentile d₁₀ of the first SiC particle powder is greater than 1 micron and even more preferably greater than 3 microns. This difference represents, according to the invention, the amount of overlap of the particle size distribution of the two powders.

Preferably, according to the invention, the difference between the percentile d₉₀ of the second SiC particle powder and the percentile d₁₀ of the first SiC particle powder is less than 20 microns, for example equal to 15 microns or less or even 10 microns or less.

Advantageously, the median diameter of the particles of the first SiC particle powder is less than 3 microns and preferably less than or equal to 1 micron. Without departing from the scope of the invention, the median diameter of the particles of the first SiC powder could be of the order of a few tens of nanometers, or even of the order of a few nanometers.

Preferably, the median diameter of the particles constituting the second SiC particle powder may be between 5 and 60 microns, preferably between 5 and 30 microns or even between 5 and 20 microns. Below 5 microns, no significant difference was observed in comparison with porous materials obtained using the conventional processes. Above 60 microns, the mechanical strength of the porous body drops very greatly.

Preferably, the median diameter of the SiC particles of the second powder is at least five times greater than the median diameter of the SiC particles of the first powder, preferably at least ten times greater.

Preferably, the difference between the median diameter of the second powder and that of the first powder is between 8 and 30 microns.

Typically, according to the invention, the ratio R₁ of the difference between the percentiles d₁₀ and d₉₀ to the median diameter d₅₀ of the first powder:

$${R}_{1} = \frac{{d}_{10} - {d}_{90}}{{d}_{50}}$$

is between 0.1 and 10, preferably between 0.3 and 5 and very preferably between 0.5 and 5.

Likewise, according to the invention, the ratio R₂ of the difference between the percentiles d₁₀ and d₉₀ to the median diameter d₅₀ of the second powder:

$${R}_{2} = \frac{{d}_{10} - {d}_{90}}{{d}_{50}}$$

is typically between 0.1 and 10, preferably between 0.3 and 5 and very preferably between 0.5 and 5.

Preferably, the porous body has an open porosity of between 35 and 65% and even more preferably between 400 and 60%. Especially in the particulate filter application, too low a porosity leads to too high a pressure drop. Too high a porosity leads to too low a mechanical strength level.

According to the invention, the median diameter d₅₀ by volume of the pores constituting the porosity of the material is between 5 and 30 microns and preferably between 10 and 25 microns.

In general, in the application of the material as constituent of the filtering walls of a particulate filter, it is generally accepted that too low a pore diameter leads to too high a pressure drop, whereas too high a median pore diameter leads to poor filtration efficiency.

Especially so as to increase the electrical conductivity properties of the porous body or to increase the mechanical strength of the porous body, the SiC powder may be made of SiC doped with a metal such as aluminum.

Moreover, the SiC powders used in the process according to the invention are preferably those of SiC in an essentially alpha crystallographic form, preferably black SiC or green SiC depending on the chemical purity of the powders used.

So as not to unnecessarily burden the present description, all the possible combinations according to the invention between the various preferred embodiments of the invention, as described above, are not reported, especially all the possible combinations resulting from the characteristics of the powders according to the invention given above. However, it is understood that all possible combinations of the initial and/or preferred ranges and values described above are envisioned and must be considered as being described by the applicant within the context of the present description (especially two, three or more combinations).

Typically, in step b), pore formers and/or binding agents and optionally plasticizers may be added. These binding agents or plasticizers are for example chosen from the range of polysaccharides and cellulose derivatives, PVAs, PEGs or even lignone derivatives or chemical setting agents such as phosphoric acid or sodium silicate, provided that these are compatible with the firing process. The applicant has observed that the rheology of the plastic blend thus obtained can be easily controlled by routine experiments, including in the case of substantial additions of water.

Advantageously, in a prior step, the particles of the first powder may be agglomerated with at least one portion of the second powder or even without the latter, using a known process for the agglomeration or formation of granules, such as conventional granulation or atomization processes. The binder for producing these granules may for example be a thermosetting resin, chosen from epoxy, silicone, polyimide or polyester resins, or preferably a phenolic resin, a PVA optionally combined with binders of the mineral or organomineral type, or an acrylic resin preferably chosen for environmentally friendly reasons. The nature of the binder and its amount are in general chosen according to the particle size distribution of the fine starting SiC powders and to the desired size of the SiC granules obtained after agglomeration. The binder must provide sufficient mechanical integrity in order for the granules not to be degraded before any binder-removal heat treatment (step c)) and above all during the forming operation (step b)).

As is known, to obtain wall porosity levels of the structure that are compatible with use as a particulate filter, i.e. typically between 35 and 65, it is in general necessary to additionally introduce, into the blend, organic pore-forming agents. These organic pore-forming agents are vaporized at relatively high temperature during the firing. Pore-forming agents such as polyethylene, polystyrene, starch or graphite are described in patent applications JP 08-281036 or EP 1 541 538.

The operation of forming the porous product (step b)) is preferably carried out so as to produce parts of various shapes using any known technique, for example by pressing, extrusion or vibration or by molding or casting, whether under pressure or not, for example in a porous plaster or resin mold. According to one possible embodiment, the sizes of the granules resulting from agglomerating the fine particles of the first SiC powder and/or the SiC particles constituting the second powder are adapted, depending on the techniques involved, to the thickness of the part to be produced so as to ensure that the porosity and mechanical strength properties and the appearance necessary for the desired application are obtained. Furthermore, it has been observed that by reducing the amount of fines, agglomerated in granule form according to the invention, it is possible to prevent the molds from becoming clogged during casting or to reduce delamination effects in the case of pressing blends.

The solvent may be removed during step c) by a heat treatment or alternatively by using microwaves, for a time long enough to bring the content of chemically unbound water to less than 1% by weight. Of course, other equivalent known means may be envisioned without departing from the scope of the present invention.

The binder removal operation (step c)) is preferably carried out in air and at a temperature preferably below 700° C. so as to ensure sufficient mechanical integrity before the sintering and to prevent uncontrolled oxidation of the SiC.

The firing is carried out at high temperature, i.e. at a temperature above 1600° C., or even above 1800° C. and preferably above 2000° C. and even more preferably above 2100° C., but below 2400° C. Preferably, said firing is carried out in a nonoxidizing atmosphere, for example an argon atmosphere.

The invention also relates to a porous body made of recrystallized SiC, preferably in essentially the α-form, obtained by a process as described above and to its use as a particulate filter structure in an exhaust line of a diesel or gasoline engine or as a firing support or as a ceramic igniter.

In comparison with a porous body of the same shape and having porosity characteristics that are comparable, but obtained using a prior process in which the particle size distribution of the SiC powders and the amount of organic material are not correlated, the porous body obtained according to the process of the invention has a higher mechanical strength characteristic, in particular a higher MOR.

The advantages described above are illustrated by the nonlimiting examples that follow, illustrating certain embodiments of the invention. The following examples allow comparison with products obtained according to the prior processes.

### EXAMPLES 1 TO 3

The blends of Examples 1 to 3 according to the invention were produced according to the compositions by weight specified in Table 2 below based on two SiC powders of different particle size distributions, called fine and coarse powders, with reference to the respective size of the particles of which they are composed. A plasticizing binder, of the methylcellulose type, and an organic pore former, of the polyethylene type, in the form of a powder of 15 micron median diameter were added to the SiC powder blend. The blends were mixed for 10 minutes in the presence of water in a mixer until a homogeneous paste was obtained. The paste was drawn out for 30 minutes so as to make it plastic and to allow deaeration of the blend.

In Table 2, the additions of water, pore former and binder-plasticizer are expressed as percentages by weight relative to the weight of the dry blend. The pore former and binder volumes are expressed in equation Y of Table 2 as a percentage by volume relative to the total volume of the SiC particles present.

Honeycomb monoliths were extruded by means of a suitably shaped die, making it possible to obtain the dimensional characteristics of the structure after extrusion as indicated in Table 1 below:

TABLE 1

| Channel/monolith geometry | Square | |
|---|---|---|
| Channel density | 180 | cpsi |
| | (channels per square inch; | |
| | 1 inch = 2.54 cm), i.e. | |
| | 27.9 channels/cm² | |
| Internal wall thickness | 350 | microns |
| Mean external wall | 600 | microns |
| thickness | | |
| Length | 25.4 | cm |
| Width | 3.6 | cm |

According to the techniques of the prior art, for example those described in patents EP 1 403 231, EP 816 065, EP 1 142 619, EP 1 455 923 or WO 2004/090294, the extruded products were dried at 110° C., underwent binder removal at 600° C. in air, and fired in argon at 2200° C., held for a time of 6 h.

Porosity and mechanical strength characteristics were determined on monoliths and these are expressed in Table 2.

The open porosity was measured on the extruded honeycomb monoliths by immersion and a vacuum according to the ISO 5017 standard. The median pore diameter was measured by mercury porosimetry.

The force at break was measured at room temperature for each example on ten test specimens corresponding to individual elements (monoliths) of a given manufacturing batch measuring 25.4 cm in length by 36 mm in width. The three-point bending setup according to the NFB41-104 standard had a distance of 220 mm between the two lower supports and the rate at which the punch was lowered was constant and around 5 mm/min.

The main characteristics and the results obtained for the filters according to Examples 1 to 3 are given in Table 2.

For comparison, another blend (Comparative Example 1c) was produced using the same steps and the same experimental protocol as described above and so as to obtain porosity characteristics substantially equivalent to those of Examples 1 to 3 according to the invention, but this time starting with an α-SiC powder currently sold by Saint-Gobain Materials under the reference SIKA TECH DPF-C. The process according to Comparative Example 1c differs from that forming the subject matter of the present invention in that the characterizing parameter Y is too low, because of too small a difference between the d₉₀ of the powder of coarser-diameter particles and the d₁₀ of the powder of smaller-diameter particles. The main characteristics and results obtained for the filter according to this comparative example are also given in Table 2.

Table 2 shows that the recrystallized SiC materials constituting the monoliths produced according to Examples 1 to 3 and Comparative Example 1c have substantially the same porosity characteristics (total pore volume and median pore diameter). However, the structures according to the invention of Examples 1 to are characterized by a substantially higher mechanical strength than that of Comparative Example 1c, as the respective MOR strength values obtained indicate.

TABLE 2

| Example No. | | | |
|---|---|---|---|
| 1 | 2 | 3 | 1c |
| invention | invention | invention | comparative |

Preparation of the blend

| | | | | |
|---|---|---|---|---|
| coarse SiC powder: | 70 | | | |
| d₅₀ = 25 μm d₁₀ = 48 μm; d₉₀ = 16.5 μm | | | | |
| coarse SiC powder: | | 70 | | |
| d₅₀ = 20 μm d₁₀ = 28 μm; d₉₀ = 10.5 μm | | | | |
| coarse SiC powder: | | | 70 | |
| d₅₀ = 10 μm d₁₀ = 15 μm; d₉₀ = 8 μm | | | | |
| coarse SiC powder: | | | | 70 |
| d₅₀ = 10 μm d₁₀ = 25 μm; d₉₀ = 5 μm | | | | |
| fine SiC powder: | 30 | 30 | 30 | 30 |
| d₅₀ = 0.5 μm d₁₀ = 1.5 μm; d₉₀ = 0.3 μm | | | | |
| polyethylene pore former: | +5 | +5 | +5 | +5 |
| d₅₀ = 15 μm (wt %) | | | | |
| methylcellulose forming additive (wt %) | +8 | +8 | +8 | +8 |
| addition of water (wt %) | +22 | +22 | +30 | +22 |

Characteristics of the blend

| | | | | |
|---|---|---|---|---|
| vol % of added pore former relative to | 37 | 37 | 37 | 37 |
| the total volume of SiC | | | | |
| vol % of methylcellulose additive added | 20 | 20 | 20 | 20 |
| relative to the total volume of SiC | | | | |
| [d₉₀ (coarse) − d₁₀ (fine)] (μm) | 15 | 9 | 6.5 | 3.5 |
| d₅₀ (coarse) (μm) | 25 | 20 | 10 | 10 |
| d₅₀ (fine) (μm) | 0.5 | 0.5 | 0.5 | 0.5 |
| [d₅₀ (coarse) − d₅₀ (fine)] (μm) | 24.5 | 19.5 | 9.5 | 9.5 |

Characteristics of the SiC material
obtained after 2200° C./Ar/6 h firing

| | | | | |
|---|---|---|---|---|
| pore volume PV (%) | 46 | 47 | 48 | 48 |
| d₅₀ of the pores (μm) | 17.0 | 14.0 | 13.0 | 16.0 |
| MOR (MPa): three-point measurement | 40 | 44 | 47 | 32 |

Process parameter

| | | | | |
|---|---|---|---|---|
| Y = [d₉₀ (coarse) − d₁₀ (fine)] × | 855.0 | 513.0 | 370.5 | 199.5 |
| [vol % pore former + vol % methyl- | | | | |
| cellulose] | | | | |

### EXAMPLES 4 TO 6

Other blends were produced using the same steps and the same experimental protocol as described above in order to obtain monoliths having the same dimensions (cf. Table 1). According to these examples, the composition of the coarse and fine SiC powder blends and the amount of organic material added to the initial blend were adjusted so as to increase the porosity characteristics of the target porous material. Table 3 gives the details of the preparation of the blend, its composition and the porosity characteristics of the material finally obtained after firing.

As a comparison, another blend (Comparative Example 2c) was produced using the same steps and the same experimental protocol as described above, so as to obtain porosity characteristics substantially equivalent to those of Examples 4 to 6 according to the invention. The process according to Comparative Example 2c is distinguished from that forming the subject matter of the present invention in that the parameter Y is too low, mainly because of the closeness between the d₉₀ of the powder of coarser-diameter particles and the d₁₀ of the powder of smaller-diameter particles. The negative value of the process parameter Y in the case of Example 2c is thus explained by there being a partial overlap between the two particle size distribution curves of the powders.

TABLE 3

| Example No. | | | |
|---|---|---|---|
| 4 | 5 | 6 | 2c |
| invention | invention | invention | comparative |

Preparation of the blend

| | | | | |
|---|---|---|---|---|
| coarse SiC powder: | 70 | | | |
| d₅₀ = 20 μm d₁₀ = 28 μm; d₉₀ = 10.5 μm | | | | |
| coarse SiC powder: | | | 70 | |
| d₅₀ = 15 μm d₁₀ = 30 μm; d₉₀ = 8.5 μm | | | | |
| coarse SiC powder: | | 70 | | 70 |
| d₅₀ = 10 μm d₁₀ = 25 μm; d₉₀ = 5 μm | | | | |
| fine SiC powder: | 30 | 30 | 30 | |
| d₅₀ = 0.5 μm d₁₀ = 1.5 μm; d₉₀ = 0.3 μm | | | | |
| fine SiC powder: | | | | 30 |
| d₅₀ = 2 μm d₁₀ = 7.1 μm; d₉₀ = 0.6 μm | | | | |
| polyethylene pore former: | +17 | +15 | +15 | +17 |
| d₅₀ = 15 μm (wt %) | | | | |
| methylcellulose forming additive (wt %) | +8 | +8 | +8 | +8 |
| addition of water (wt %) | +30 | +30 | +30 | +30 |

Characteristics of the blend

| | | | | |
|---|---|---|---|---|
| vol % of added pore former relative to | 82 | 77 | 77 | 82 |
| the total volume of SiC | | | | |
| vol % of methylcellulose additive added | 20 | 20 | 20 | 20 |
| relative to the total volume of SiC | | | | |
| [d₉₀ (coarse) − d₁₀ (fine)] (μm) | 9 | 3.5 | 7 | −2.1 |
| d₅₀ (coarse) (μm) | 20 | 10 | 15 | 10 |
| d₅₀ (fine) (μm) | 0.5 | 0.5 | 0.5 | 2 |
| [d₅₀ (coarse) − d₅₀ (fine)] (μm) | 19.5 | 9.5 | 14.5 | 8 |

Characteristics of the SiC material
obtained after 2200° C./Ar/6 h firing

| | | | | |
|---|---|---|---|---|
| pore volume PV (%) | 61 | 60 | 61 | 62 |
| d₅₀ of the pores (μm) | 23.0 | 25.0 | 24.0 | 23.0 |
| MOR (MPa): three-point measurement | 10 | 9 | 12 | 5 |

Process parameter

| | | | | |
|---|---|---|---|---|
| Y = [d₉₀ (coarse) − d₁₀ (fine)] × | 918 | 339.5 | 679 | −214 |
| [vol % pore former + vol % methyl- | | | | |
| cellulose] | | | | |

The experimental data given in Table 3 show that the recrystallized SiC materials constituting monoliths produced according to Examples 4 to 6 and Comparative Example 2c have substantially the same porosity characteristics (total pore volume and median pore diameter). As previously, the structures according to the invention of Examples 4 to 6 are characterized by a substantially higher mechanical strength than that of Comparative Example 2c, as the respective MOR strength values obtained indicate.

### EXAMPLE 7

Another blend was produced using the same steps and the same experimental protocol as described above in order to obtain monoliths having the same dimensions (cf. Table 1). According to this example, the composition of the blends of coarse and fine SiC powders and the amount of organic material added to the initial blend were adjusted so as again to improve the porosity characteristics of the target porous material and especially the pore diameter of the porous structure. Table 4 shows in detail the preparation of the blend, its composition and the porosity characteristics of the material finally obtained after firing.

For comparison, another blend (Comparative Example 3c) was produced using the same steps and the same experimental protocol as that described above, but so as to obtain porosity characteristics substantially equivalent to those of Example 7 according to the invention. The process according to Comparative Example 3c differs from that forming the subject matter of the present invention in that the parameter Y is too high, firstly because of the large difference between the d₉₀ of the powder of coarser-diameter particles and the d₁₀ of the powder of smaller-diameter particles and secondly because of the very large addition of pore-forming agent necessary for obtaining the target porosity parameters (cf. Table 4).

TABLE 4

| Example No. | |
|---|---|
| 7 | 3c |
| invention | comparative |

Preparation of the blend

| | | |
|---|---|---|
| coarse SiC powder: | | 70 |
| d₅₀ = 60 μm d₁₀ = 90 μm; d₉₀ = 35 μm | | |
| coarse SiC powder: | 70 | |
| d₅₀ = 30 μm d₁₀ = 45 μm; d₉₀ = 18 μm | | |
| fine SiC powder: | 30 | 30 |
| d₅₀ = 2 μm d₁₀ = 7.1 μm; d₉₀ = 0.6 μm | | |
| polyethylene pore former: | +17 | +19 |
| d₅₀ = 15 μm (wt %) | | |
| methylcellulose forming additive (wt %) | +8 | +8 |
| addition of water (wt %) | +30 | +30 |

Characteristics of the blend

| | | |
|---|---|---|
| vol % of added pore former relative to | 82 | 99 |
| the total volume of SiC | | |
| vol % of methylcellulose additive added | 20 | 20 |
| relative to the total volume of SiC | | |
| [d₉₀ (coarse) − d₁₀ (fine)] (μm) | 10.9 | 27.9 |
| d₅₀ (coarse) (μm) | 30 | 60 |
| d₅₀ (fine) (μm) | 2 | 2 |
| [d₅₀ (coarse) − d₅₀ (fine)] (μm) | 28 | 58 |

Characteristics of the SiC material
obtained after 2200° C./Ar/6 h firing

| | | |
|---|---|---|
| pore volume PV (%) | 62 | 63 |
| d₅₀ of the pores (μm) | 30.0 | 36.0 |
| MOR (MPa): three-point measurement | 6 | 2.5 |

Process parameter

| | | |
|---|---|---|
| Y = [d₉₀ (coarse) − d₁₀ (fine)] × | 1112 | 3320 |
| [vol % pore former + vol % methyl- | | |
| cellulose] | | |

The experimental data given in Table 4 show that the recrystallized SiC materials constituting the monoliths produced according to Example 7 and Comparative Example 3c have substantially the same porosity characteristics (total pore volume and median pore diameter). However, the structure of Example 7 according to the invention is characterized by a substantially higher mechanical strength than that of Comparative Example 3c, as the respective MOR strength values obtained indicate.

The above examples show the superiority of the porous structures obtained by applying the process according to the invention, the mechanical performance levels of which are very substantially improved.

1. A process for obtaining a porous material comprising recrystallized SiC comprising:
a) preparing a composition comprising two powders of SiC particles, the particles of a first powder having a median diameter d₅₀ of less than 5 microns and the particles of a second powder having a median diameter d₅₀ of between 5 and 100 microns, the difference between the median diameter d₅₀ of the second powder and the median diameter d₅₀ of the first powder being greater than 5 microns;
b) blending said composition with an organic material comprising an organic pore former and/or a binder, in suitable proportions and in the presence of a sufficient amount of a solvent, such as water, to allow said blend to be formed, and forming of the blend obtained in order to obtain a green body;
c) optionally drying and removing the organic material by an intermediate heat treatment and/or by the use of microwaves; and
d) firing of the body at a sintering temperature between 1600° C. and 2400° C., preferably above 1800° C. or even above 2000° C., in order to obtain a sintered porous body,
wherein the difference between the percentile d₉₀ of the second particle powder and the percentile d₁₀ of the first particle powder multiplied by the volume of organic material in the initial blend, expressed as a percentage relative to the total volume of the SiC particles, is between 250 and 1500.

2. The process as claimed in claim 1, wherein the difference between the percentile d₉₀ of the second SiC particle powder and the percentile d₁₀ of the first SiC particle powder is greater than 1 micron.

3. The process as claimed in claim 1, wherein the difference between the percentile d₉₀ of the second SiC particle powder and the percentile d₁₀ of the first SiC particle powder is less than 20 microns.

4. The process as claimed in claim 1, wherein the median diameter d₅₀ of the first SiC particle powder is less than 3 microns.

5. The process as claimed in claim 1, wherein the median diameter of the particles of the second SiC particle powder is between 5 microns and 60 microns.

6. The process as claimed in claim 1, wherein the median diameter of the second SiC particle powder is at least five times greater than the median diameter of the first SiC particle powder.

7. The process as claimed in claim 1, wherein the difference between the median diameter d₅₀ of the second particle powder and the median diameter d₅₀ of the first particle powder is between 8 microns and 30 microns.

8. The process as claimed in claim 1, wherein the ratio R₁ of the difference between the percentiles d₁₀ and d₉₀ to the median diameter d₅₀ of the first powder:
$${R}_{1} = \frac{{d}_{10} - {d}_{90}}{{d}_{50}}$$
is between 0.1 and 10.

9. The process as claimed in claim 1, wherein the ratio R₂ of the difference between the percentiles d₁₀ and d₉₀ to the median diameter d₅₀ of the second powder:
$${R}_{2} = \frac{{d}_{10} - {d}_{90}}{{d}_{50}}$$
is between 0.1 and 10.

10. The process as claimed in claim 9, wherein the binder used in b) is chosen from the group formed by a thermosetting resins resin.

11. The process as claimed in claim 1, wherein the SiC particles are in the α-form.

12. The process as claimed in claim 1, wherein the green body is formed in step b) by pressing, extrusion or vibration or by molding or casting, optionally under pressure.

13. A porous material comprising recrystallized SiC, wherein the total pore volume of which is between 35% and 65%, which can be obtained by a process as claimed in claim 1.

14-15. (canceled)

16. The process of claim 10, wherein the thermosetting resin is at least one resin selected from the group consisting of an epoxy resin, a silicone resin, a polyimide resin, a polyester resin, a phenolic resin, and PVA.

17. A particulate filter structure comprising the porous material of claim 13.

18. A firing support or a ceramic igniter comprising the porous material of claim 13.
